(19) United States
(12) Patent Application Publication
(10) Pub. No.: US 2026/0017597 A1
(43) Pub. Date: Jan. 15, 2026

(54) SNAP-IN AS A CONTAINER FOR BUSINESS PROCESS INFRASTRUCTURE

(71) Applicant: DevRev, Inc., Palo Alto, CA (US)

(72) Inventors: Umang Malik, Ghaziabad (IN); Kapil Garg, Bengaluru (IN); Harpinder Singh, Bengaluru (IN); Abhishek Bansal, Mandi Dabwali (IN); Peter Marinšek, Ljubljana (SI); Luka Košenina, Ljubljana (SI)

(73) Assignee: DevRev, Inc., Palo Alto, CA (US)

(21) Appl. No.: 18/769,324

(22) Filed: Jul. 10, 2024

(51) Int. Cl. G06Q 10/067

(52) U.S. Cl. CPC G06Q 10/067

(57) ABSTRACT

Disclosed is a business process infrastructure container system. The system includes one or more business process infrastructure modules configured to perform a user-desired operation on a client platform. The system also includes a manifest file having details of one or more business process infrastructure modules. The system further includes computer-readable instructions configured to trigger the user-desired operation via one or more business process infrastructure modules and the manifest file.

### FIELD OF INVENTION

Embodiments of the present disclosure pertain to business process management and execution, and more particularly, to a system designed to define, package, and execute, business processes on a platform to form the business process infrastructure.

### BACKGROUND

In today's rapidly evolving business landscape, organizations constantly seek ways to streamline their operations, enhance efficiency, and remain competitive. Traditional methods of managing business processes often involve manual interventions, complex integrations, and significant overhead costs. This has led to an increased demand for solutions that can simplify business process management and reduce the dependency on human intervention.

For example, running a business on a cloud platform involves integrating various software components such as automations, dashboards, commands, templates, and webhooks. These components must be cohesively stitched together to form an efficient and functional infrastructure. While low-level APIs are typically utilized to construct each of these individual components, directly using these APIs may present some issues.

As the number and complexity of the software components increase, managing them for a business becomes substantially difficult. Businesses often encounter challenges in coordinating and maintaining a multitude of disparate elements, leading to inefficiencies, errors, and increased operational costs. The complexity involved in manually handling these components can be overwhelming for IT teams of organizations, resulting in a cumbersome and error-prone process.

Moreover, the existing low-level APIs for business processes do not provide an adequate abstraction to facilitate this process. Organizations spend considerable time and resources to develop custom solutions to package and share their business process components, which may hamper scalability and reusability. This lack of standardization and distribution issues makes it difficult for businesses to leverage shared infrastructure effectively.

### SUMMARY

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a business process infrastructure container system is provided. The system includes one or more business process infrastructure modules configured to perform a user-desired operation on a client platform. The system also includes a manifest file having details of one or more business process infrastructure modules. The system further includes computer-readable instructions configured to trigger the user-desired operation via one or more business process infrastructure modules and the manifest file.

According to another example embodiment, a business process infrastructure platform is provided. The platform includes a user interface that is configured to receive inputs from a user to package a business process infrastructure container system. The business process infrastructure container system is configured to perform a desired operation for the user. The platform also includes one or more business process infrastructure modules and a manifest file having details of one or more infrastructure modules. The platform further includes computer-readable instructions configured to trigger the user-desired operation via one or more infrastructure modules and the manifest file. The platform is configured to select one or more business process infrastructure modules and package the selected modules with the manifest file in a business process infrastructure container system based on the inputs.

According to another example embodiment, a business process infrastructure platform is provided. The platform includes a memory storing one or more processor-executable routines and a processor communicatively coupled to the memory. The processor is configured to execute one or more processor-executable routines to receive inputs from a user to package a business process infrastructure container system. The business process infrastructure container system is configured to perform a desired operation for the user. The processor is further configured to select one or more business process infrastructure modules based on the inputs and package the selected modules with an associated manifest file in a business process infrastructure system. The manifest file includes a YAML file and the business process infrastructure modules include computer-readable instructions configured to trigger the desired operation.

According to another example embodiment, a method for implementing a business process for a client platform is disclosed. The method includes receiving inputs from a user of the client platform corresponding to a desired operation to be performed on the platform. The method further includes packaging a business process infrastructure container system to perform the desired operation. The business process infrastructure container system includes one or more business process infrastructure modules and a corresponding manifest file with associated details of the business process infrastructure modules. The method further includes deploying the packaged business process infrastructure container system on the client platform.

### BRIEF DESCRIPTION OF THE DRAWINGS

The disclosure will be described and explained with additional specificity and detail with the accompanying figures in which:

FIG. 1 is a block diagram illustrating components of a business process infrastructure platform, according to some aspects of the present description;

FIG. 2 is a block diagram that illustrates components of the business process infrastructure platform of FIG. 1, according to some aspects of the present description;

FIG. 3 illustrates an example of a business process infrastructure platform having one or more business process infrastructure container systems of FIG. 1;

FIG. 4 illustrates an example process flow for developing one or more business process infrastructure containers by developers using the business process infrastructure platform of FIG. 1;

FIG. 5 illustrates an example process flow of instantiating one or more business process infrastructure container systems using the business process infrastructure platform of FIG. 1;

FIG. 6 illustrates an example process flow for auto-upgradation of one or more business process infrastructure container systems within the business process infrastructure platform of FIG. 1;

FIG. 7 illustrates a flow chart of the process of implementation of one or more business process infrastructure containers on a client platform using the business process infrastructure platform;

FIG. 8 is a block diagram of an embodiment of a computing device in which the business process infrastructure container system, described herein, is implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for a business process infrastructure container system and platform.

Embodiments of the invention provide a business process infrastructure container system and platform designed to facilitate the management, deployment, and distribution of business process components. These embodiments address significant challenges of conventional business process management systems that often struggle with the complexity of managing numerous software components and lack standardized methods for packaging and sharing infrastructure. The embodiments of the invention facilitate creation of business process infrastructure modules that include a manifest file and computer-readable instructions to trigger user-desired operations for the organizations. This allows users to easily package, customize, deploy, and manage their business process infrastructure, enhancing overall efficiency, scalability, and reusability.

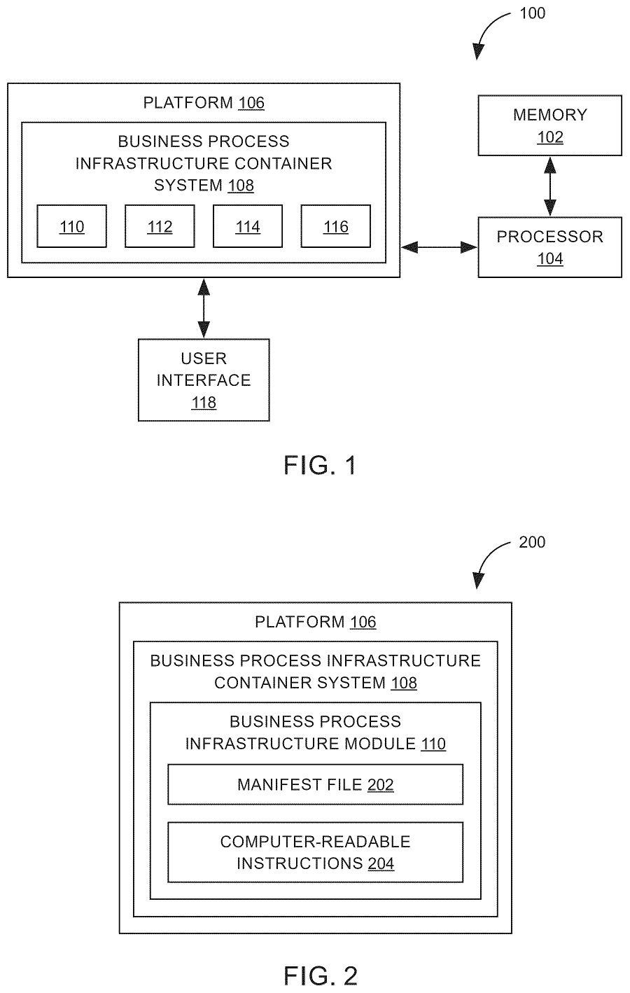

FIG. 1 is a block diagram 100 illustrating components of a business process infrastructure platform 106 to implement some embodiments of the invention. The components include a memory 102, a processor 104, and a user interface 118. The memory 102 is configured to store one or more processor-executable routines and the processor 104 is communicatively coupled to the memory 102 to execute the one or more processor-executable routines to enable operation of the platform 106. The user interface 118 is configured to receive inputs from a user to package a business process infrastructure container system generally represented by reference numeral 108. In the example embodiment, the business process infrastructure container system 108 comprises one or more business process infrastructure modules, such as represented by reference numerals 110, 112, 114, and 116.

The business process infrastructure platform 100 is configured to receive user inputs related to the desired operations to be performed on the platform 106 via the user interface 118. The business process infrastructure modules 110, 112, 114, and 116, may be selected and configured based on user inputs and may be packaged as the business process infrastructure container system 108. Each of these business process infrastructure modules 110, 112, 114, and 116 are configured to perform a specific operation for the business process. Examples of business process infrastructure modules such as 110 include automation modules, commands, dashboards, webhooks, or combinations thereof.

The business process infrastructure container system 108 also includes a manifest file that has details of one or more business process infrastructure modules. In addition, the business process infrastructure container system 108 includes computer-readable instructions configured to trigger the user-desired operation via one or more business process infrastructure modules 110, 112, 114, and 116 and the manifest file. The business process infrastructure platform 100 is configured to select one or more business process infrastructure modules 110, 112, 114, and 116 and package the selected business process infrastructure modules with the manifest file in the business process infrastructure container system 108 based on the user inputs. The business process infrastructure container system 108 is further described with reference to FIG. 2.

FIG. 2 illustrates components 200 of the business process infrastructure platform 106 of FIG. 1. As illustrated, the business process infrastructure platform 106 includes a business process infrastructure container system 108, one or more business process infrastructure modules 110, a manifest file 202, and computer-readable instructions 204.

The business process infrastructure container system 108 is configured to facilitate the execution of user-desired operations. This business process infrastructure container system 108 leverages a modular architecture, and allows users to select and configure specific business process infrastructure modules 110 to meet their operational needs. In this embodiment, the manifest file 202 includes details of the business process infrastructure modules 110. Moreover, the computer-readable instructions 204 are configured to trigger the user-desired operation via one or more business process infrastructure modules 110 and the manifest file 202.

The business process infrastructure platform 106 is configured to provide user access to a wide range of business process infrastructure modules 110. In this embodiment, the business process infrastructure platform 106 offers a user-friendly interface to access a plurality of business process infrastructure module 110 that are available for deployment for an organization. Each of these business process infrastructure modules 110 serves a specific purpose and may be combined with other business process infrastructure modules to create a tailored solution for the user. As previously described, the business process infrastructure modules 110 may include, but are not limited to, automation tools, commands, dashboards, webhooks, and the combination thereof and are configured to provide a versatile and configurable business infrastructure for an organization.

The business process infrastructure platform 106 is configured to provide an automatic update feature. In particular, the business process infrastructure platform 106 is configured to detect a version change of one or more business process infrastructure modules 110 and automatically creates and/or updates resources and processes the computer-readable instructions 204 to update one or more business process infrastructure modules 110. Alternately, the business process infrastructure platform 106 is configured to detect if one or more business process infrastructure module 110 is deleted from the business process infrastructure platform 106 and accordingly automatically deletes associated resources with the deleted business process infrastructure module 110.

This feature eliminates the need for manual updates, ensuring that all business process infrastructure modules 110 are consistently up-to-date thereby enhancing system reliability, security, and functionality. In this embodiment, the automatic updates occur seamlessly while minimizing any disruption to the ongoing operations of the user.

Moreover, the manifest file 202 includes detailed information about the business process infrastructure modules 110. In this example, the manifest file 202 is a YAML (YAML Ain't Markup Language) file and includes module details such as name, description, access permissions, or combinations thereof. The YAML file 202 further includes detailed information about the connections between one or more business process infrastructure modules 110 that facilitate the integration of the modules. The YAML file 202 includes configurable inputs that enable the deployment of the business process infrastructure container system 108 on a new platform by adjusting the necessary parameters.

The computer-readable instructions 210 are configured to trigger the user-desired operations by leveraging the information in the manifest file 202 and the capabilities of the business process infrastructure module 110. The system 100 supports receiving these instructions through programming languages such as Typescript or JavaScript, providing flexibility and ease of integration with various platforms.

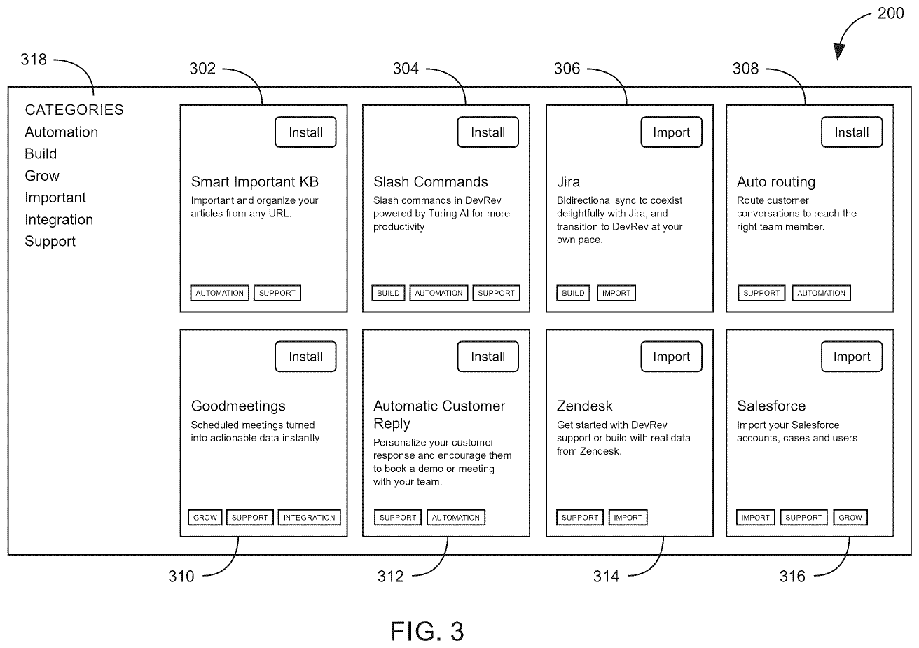

FIG. 3 illustrates an example 300 of business process infrastructure platform having one or more business process infrastructure container systems such as 108 of FIG. 1, implemented according to aspects of the present invention. In this example, the business process infrastructure platform 300 is configured to offer a plurality of business process infrastructure container systems to users, and each business process infrastructure container system is configured to perform a specific operation.

For example, the business process infrastructure platform 300 includes systems such as smart import KB (302), Slash commands (304), Jira (306), Auto routing (308), Good meetings (310), Automatic customer reply (312), Zendesk (314), Salesforce (316). Each of these systems 302, 304, and 306, among others, are containerized with requisite business process infrastructure modules 110 to perform the desired function. In certain embodiments, a user may browse the business process infrastructure container systems on the business process infrastructure platform 300 based on categories 318 such as automation, build, grow, and so forth. Accordingly, the user may select the business process infrastructure container systems from the respective categories for their organization.

In one example, the business process infrastructure platform 300 offers a business process infrastructure container system 108 referred to as Github that may be available for instantiating on a client platform is described below. In this embodiment, GitHub provides a collaborative environment where developers can version control their code, track issues, and manage changes. This integration enhances the efficiency and reliability of the client platform. GitHub containerization can be integrated with the described business process infrastructure platform to streamline the development, deployment, and management of business process infrastructure containers.

In one example, developers can use GitHub to host and manage their business process infrastructure modules and container systems using the business process infrastructure platform 106 of FIG. 1. For instance, once developers create new business process infrastructure modules or update existing ones, they can push their changes to a GitHub repository. This repository may act as a single source of truth, ensuring that all team members work with the latest version of the code.

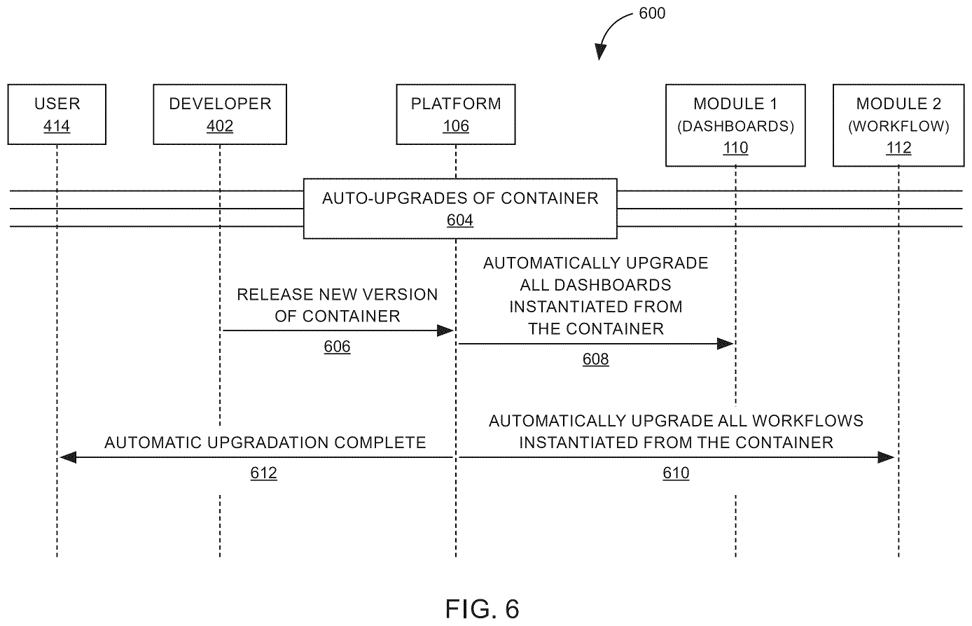

The business process infrastructure platform 300 is configured to automatically pull updates from the GitHub repository. Accordingly, when a new version of a business process infrastructure module or business process infrastructure container system is released on GitHub, the business process infrastructure platform 300 triggers a continuous integration/continuous deployment (CI/CD) pipeline to build and test the new version. Upon successful validation, the platform automatically deploys the updated business process infrastructure container system to the users, as will be described further with reference to FIG. 6.

Moreover, using GitHub Actions, developers can automate the entire workflow, from code commits to deployment. This may include running automated tests, performing security scans, and validating configurations before the business process infrastructure container system is published to the business process infrastructure platform 300. The business process infrastructure platform 300 is also configured to track the deployment history and maintain rollback capabilities in case of issues.

By leveraging GitHub's capabilities, the business process infrastructure platform 300 enhances collaboration, ensures code quality through continuous integration, and simplifies the deployment process through containerization. This integration ensures that business process infrastructure container systems are always up-to-date, secure, and efficient, providing users with the most reliable and current tools for their operations.

In one example, GitHub is used for generating a CSAT (Customer Satisfaction) survey. The business process infrastructure container system for CSAT surveys integrates seamlessly with the business process infrastructure platform 300 to enhance customer feedback collection. This business process infrastructure container system is configured to surface as a survey on the timeline of users as a comment when a conversation resolves, and it also accepts survey responses from users, storing them in the System of Record (SOR) of the business process infrastructure platform 300. In this example, a developer can create a business process infrastructure container system for surveys and may incorporate a plurality of business process infrastructure modules 110 such as commands that can be executed on a ‘Ticket’ to send the survey form to the customer.

Further, the business process infrastructure container system may include other business process infrastructure modules 110 such as configuration options to manage survey settings like questions, and rating scales, among others. Other business process infrastructure modules 110 may include custom objects for managing various kinds of surveys and their responses and dashboards that may combine the survey responses with other organizational details. For example, a dashboard showing CSAT survey ratings grouped by customer tier over time.

In this example, the manifest YAML 202 of such a survey container system may include components like command metadata, configuration options, custom objects, and their definitions, dashboards, and the underlying queries. This YAML file 202 may also specify how these various components link with each other. For instance, the underlying query for the dashboard could refer to the custom object survey response.

In operation, a CSAT survey may be implemented through the survey business process infrastructure container system. Once a customer support conversation is resolved, the business process infrastructure container system automatically surfaces a CSAT survey on the timeline as a comment. This survey might include questions such as, “How satisfied were you with the support you received?” with response options ranging from “Very Unsatisfied” to “Very Satisfied.”

The customer can provide their feedback on the survey directly within the timeline comment. The business process infrastructure container system then accepts the survey response and validates it against a pre-determined survey schema using a survey ID. Upon validation, the response is stored in the SOR, ensuring that all customer feedback is accurately recorded and accessible for future analysis.

By deploying the business process infrastructure container system, organizations can automatically prompt customers for feedback at the resolution of each conversation, streamlining the process of collecting CSAT data. This continuous feedback loop helps organizations monitor customer satisfaction, identify areas for improvement, and enhance overall service quality.

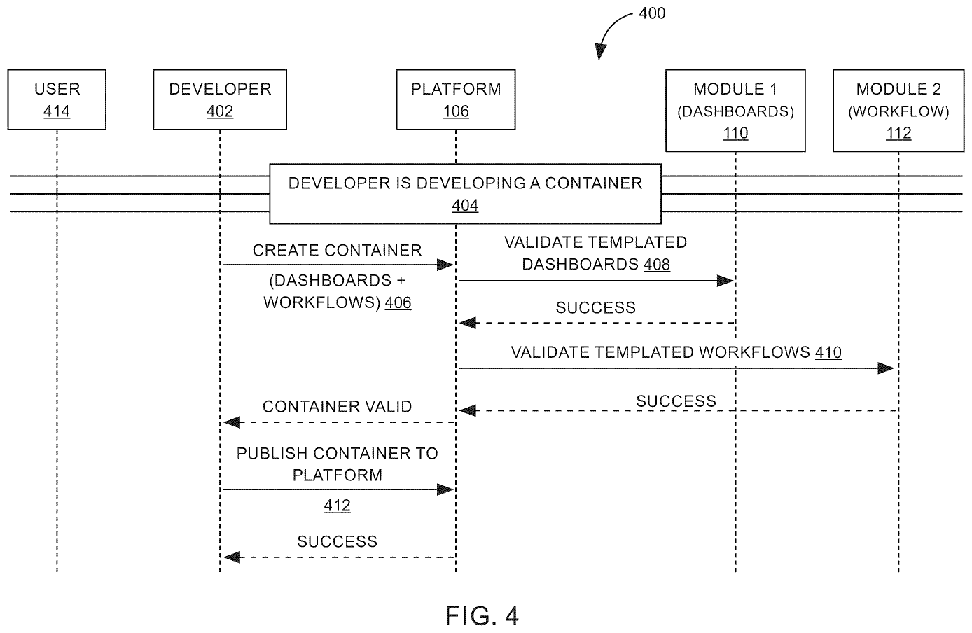

A variety of such business process infrastructure container systems may be envisaged to achieve a plurality of operations. Each of these business process infrastructure container systems may include business process infrastructure container modules such as described above along with the manifest file and compute readable instructions. FIGS. 4-6 illustrate example processes for developing and deploying such business process infrastructure container systems in organizations.

FIG. 4 illustrates an embodiment of an example process flow 400 for developing one or more business process infrastructure containers by developers using a business process infrastructure platform, such as platform 106 of FIG. 1. In this example, business process infrastructure platform 106 is configured to provide developers 402 with access to create and develop business process infrastructure container systems such as represented by reference numeral 404. In operation, developers 402 can create various business process infrastructure container systems by incorporating multiple business process infrastructure modules, such as dashboards, automation, workflows, and webhooks. For instance, developers may create a business process infrastructure container by integrating business process infrastructure modules like dashboards 110 and workflows 112, as shown at block 406. Once the business process infrastructure container system is packaged, each module such as 110 and 112 undergoes a validation process (blocks 408, 410) using the business process infrastructure platform 106.

The validation criteria may include one or more functionality, compatibility, security, performance, compliance, user experience, integration, documentation, scalability, and error handling. Each business process infrastructure module such as module 110 must be validated to ensure that it performs its intended function correctly, is compatible with other business process infrastructure modules and the client platform, is secure against vulnerabilities, operates efficiently, complies with industry standards and regulations, provides a good user experience, integrates seamlessly with other business process infrastructure modules and external systems, includes complete and accurate documentation, can handle increased load and scale as needed, and has robust error handling and logging mechanisms.

If it is detected that a business process infrastructure module such as module 110 fails validation at any point, the issues identified must be addressed by developers 402 before revalidating. The process may involve debugging code, enhancing security measures, optimizing performance, or making other necessary adjustments.

Upon successful validation of all the business process infrastructure modules in the business process infrastructure container system, it is then published (block 412) on the business process infrastructure platform 106. The published business process infrastructure container systems are subsequently made available to organizations/users for download and use.

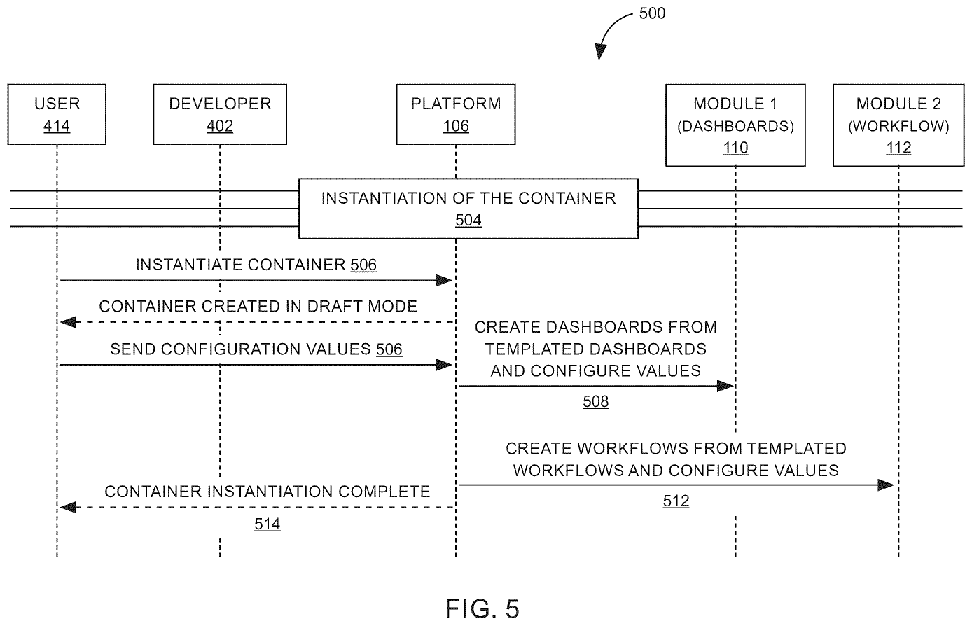

FIG. 5 illustrates an embodiment of an example process flow 500 for instantiating one or more business process infrastructure container systems by the user using a business process infrastructure platform, such as platform 106 of FIG. 1. The instantiation of the business process infrastructure container systems by the user is represented by reference numeral 504. As described before, the business process infrastructure container system is available on the business process infrastructure platform 106 for distribution and instantiation in new organizations.

In operation, user 414 initiates the instantiation of the business process infrastructure container system (block 506) corresponding to the desired operations to be performed. User 414 provides configuration values for the business process infrastructure container system 108 to the platform (block 508). These configuration values may include business process infrastructure module 110 selection (e.g., dashboards, automation, workflows, webhooks), access permissions for different users or roles, connection details for external systems or databases, parameter values for configurable settings, user interface customizations, automation rules, data sources, security settings, notification preferences, performance settings, compliance settings, and localization details, among others. For instance, the user 414 may select business process infrastructure modules such as dashboards and workflows for the business process infrastructure container system 108.

Once the user 414 has provided the configuration values/settings, the business process infrastructure platform 106 is configured to create the selected business process infrastructure module 110 based on the templated modules and configured values (blocks 510, 512). The business process infrastructure container system instantiation process (block 514) is completed and the packaged business process infrastructure container system 108 is then ready for deployment for the organization, ensuring it is tailored to the specified requirements and operational needs of the organization.

FIG. 6 illustrates an embodiment of an example process flow 600 for auto-upgradation of one or more business process infrastructure container system 108 within a business process infrastructure platform, such as platform 106 of FIG. 1. In this example, business process infrastructure platform 106 is configured to facilitate auto-upgradation of the business process infrastructure container system 108 (block 604) as and when the business process infrastructure modules 110 & 112 are upgraded. In operation, once developer 402 releases a new version of the business process infrastructure container system 108 (block 606), the platform 106 automatically upgrades all the instantiated business process infrastructure modules 110, such as dashboards and workflows, of the business process infrastructure container system 108 (blocks 608, 610). This ensures that users always have access to the latest features and improvements without manual intervention, maintaining the efficiency and effectiveness of their business processes.

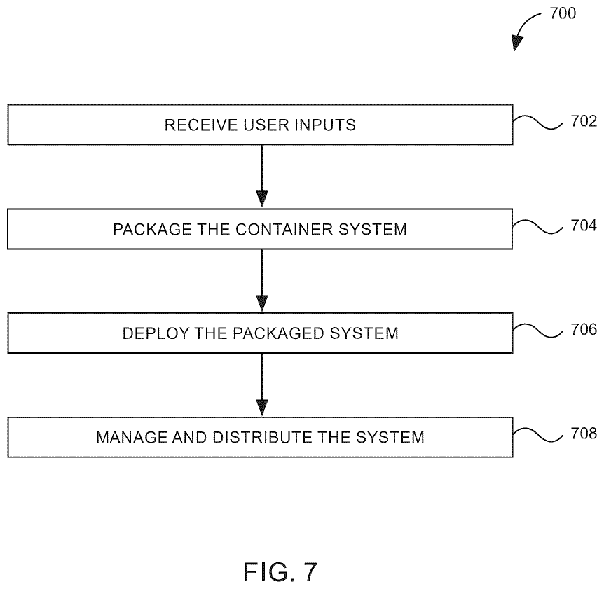

FIG. 7 is a flowchart (700) illustrating the process of implementation of one or more business process infrastructure containers 108 on a client platform using the business process infrastructure platform 106. At block 702, the platform receives inputs from a user. The inputs correspond to the desired operation to be performed via the business process infrastructure container systems.

Based on the user inputs, the business process infrastructure platform selects one or more business process infrastructure modules and packages a business process infrastructure container system designed to perform the desired operation (block 704). This business process infrastructure container system includes the selected business process infrastructure modules, along with the computer-readable instructions necessary to trigger the desired operation on the client platform. Additionally, it includes a corresponding manifest file, typically in YAML format, that provides detailed information about the selected business process infrastructure modules. The manifest file may include the names, descriptions, access permissions, interconnections, and configurable inputs for deployment on the platform, ensuring that the business process infrastructure modules are configured and integrated to execute the desired tasks effectively.

At block 706, the packaged business process infrastructure container system is deployed on the client platform. The deployment process facilitates the configuration and implementation of the business process infrastructure modules in accordance with the specifications outlined in the YAML manifest file.

At block 708, the packaged business process infrastructure container system is distributed to multiple users using the business process infrastructure platform. This may include overseeing the maintenance, updates, and availability of the packaged business process infrastructure container system to ensure that it can be effectively deployed by a plurality of users across different platforms. Advantageously, the business process infrastructure container system is scalable and accessible to multiple users, facilitating broader deployment and utilization of the packaged solution.

The business process infrastructure modules of the business process infrastructure container system 108 and the business process infrastructure platform 106, described herein, are implemented in computing devices. In certain embodiments, the business process infrastructure modules of the business process infrastructure container system 108 and the business process infrastructure platform 106 may be implemented as part of an off-premise platform such as a server or cloud based system.

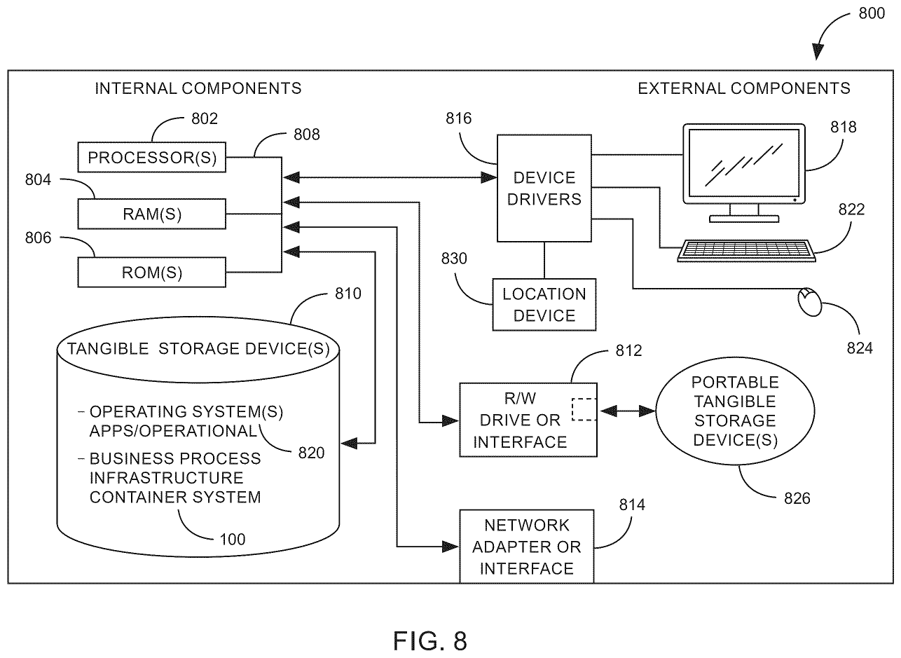

One example of a computing device (800) is described below in FIG. 8. The computing device (800) includes one or more processor(s) (802), one or more computer-readable RAMs (804), and one or more computer-readable ROMs (806) on one or more buses (808). Further, the computing device (800) includes a tangible storage device (810) that may be used to execute operating systems (820) and the business process infrastructure container system (200). The various modules of the business process infrastructure container system (200) may be stored in the tangible storage device (810). Both, the operating systems (820) and the business process infrastructure container system (200) are executed by one or more processor(s) (802) via one or more respective RAMs (804) (which typically include cache memory). The execution of the operating systems (820) and/or the business process infrastructure container system (200) by one or more processor(s) (802), configures the one or more processor(s) (802) as a special purpose processor configured to carry out the functionalities of the operation systems (820) and/or the business process infrastructure container system (108) as described above.

Examples of tangible storage devices (810) include semiconductor storage devices such as ROM, EPROM, flash memory, or any other computer-readable tangible storage device that may store a computer program and digital information.

The computing device (800) also includes an R/W drive or interface (814) to read from and write to one or more portable computer-readable tangible storage devices (828) such as a CD-ROM, DVD, memory stick, or semiconductor storage device. Further, network adapters or interfaces (812) such as TCP/IP adapter cards, wireless Wi-Fi interface cards, or 3G or 4G wireless interface cards, or other wired or wireless communication links are also included in computing devices.

In one example embodiment, the business process infrastructure container system (200) may be stored in the tangible storage device (810) and may be downloaded from an external computer via a network (for example, the Internet, a local area network, or other, wide area network) and network adapter or interface (812).

Computing device (800) further includes device drivers (816) to interface with input and output devices. The input and output devices may include a computer display monitor (818), a keyboard (822), a keypad, a touch screen, a computer mouse (824), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to an example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer-readable medium, and tangible computer program product. For example, the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple pl that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A process infrastructure container system, wherein the system comprises:
one or more process infrastructure modules that comprise software components configured to perform a user-desired operation on a client platform, wherein each of the one or more process infrastructure modules corresponds to a respective software component;
the software components are integrated by implementing multiple process infrastructure modules within the process infrastructure container system, wherein each of the one or more process infrastructure modules is deployable and combinable with another process infrastructure module;
a manifest file, wherein the manifest file comprises details of one or more process infrastructure modules; and
computer-readable instructions configured to trigger the user-desired operation via the one or more process infrastructure modules and the manifest file.

2. The process infrastructure container system of claim 1, wherein the manifest file comprises a YAML file.

3. The process infrastructure container system of claim 2, wherein the YAML file comprises name, description, access permissions, or combinations thereof for one or more process infrastructure modules.

4. The process infrastructure container system of claim 2, wherein the YAML file comprises details of connections between one or more process infrastructure modules.

5. The process infrastructure container system of claim 2, wherein the YAML file comprises configurable inputs to deploy the container system on a new platform.

6. The process infrastructure container system of claim 1, wherein the system is configured to receive the computer-readable instructions via a Typescript or JavaScript programming language.

7. The process infrastructure container system of claim 1, wherein the one or more process infrastructure modules comprise an automation module, commands, dashboards, webhooks, or combinations thereof.

8. The process infrastructure container system of claim 7, wherein the user is configured to select one or more infrastructure modules based upon the user-desired operation.

9. The process infrastructure container system of claim 1, wherein a plurality of infrastructure modules is available to the user via a process infrastructure platform.

10. The process infrastructure container system of claim 9, wherein the plurality of infrastructure modules is automatically updated upon release of a new version of the respective infrastructure module on the process infrastructure platform.

11. A process infrastructure platform, wherein the platform comprises:
a user interface configured to receive inputs from a user to package a process infrastructure container system, wherein the process infrastructure container system is configured to perform a desired operation for the user;
one or more process infrastructure modules that comprise software components, wherein each of the one or more process infrastructure modules corresponds to a respective software component;
the software components are integrated by implementing multiple process infrastructure modules within the process infrastructure container system, wherein each of the one or more process infrastructure modules is deployable and combinable with another process infrastructure module;
a manifest file, wherein the manifest file comprises details of one or more infrastructure modules; and
computer-readable instructions configured to trigger the user-desired operation via one or more infrastructure modules and the manifest file, wherein the platform is configured to select one or more process infrastructure modules and package the selected modules with the manifest file in a process infrastructure container system based on the inputs.

12. The process infrastructure platform of claim 11, wherein the platform is further configured to:
detect a change in parameters of one or more process infrastructure modules; and
automatically update one or more process infrastructure modules based on the changed parameters.

13. The process infrastructure platform of claim 12, wherein the platform is further configured to:
detect a version change of one or more process infrastructure modules; and
automatically creates and/or updates resources and processes the computer-readable instructions to update one or more process infrastructure modules.

14. The process infrastructure platform of claim 13, wherein the platform is further configured to:
detect if one or more process infrastructure modules are deleted from the platform; and
automatically delete associated resources with the deleted process infrastructure modules.

15. The process infrastructure platform of claim 11, wherein the platform is further configured to manage distribution and customization of the process infrastructure container for a plurality of users, wherein each process infrastructure container is configurable by the user based on their requirements.

16. A process infrastructure platform, wherein the platform comprises:
a memory storing one or more processor-executable routines; and
a processor communicatively coupled to the memory, the processor configured to execute one or more processor-executable routines to:
receive inputs from a user to package a process infrastructure container system, wherein the process infrastructure container system is configured to perform a desired operation for the user; and
select one or more process infrastructure modules based upon the inputs and package the selected modules with an associated manifest file in a process infrastructure container system, wherein each of the one or more process infrastructure modules corresponds to a respective software component and the software components are integrated by implementing multiple process infrastructure modules within the process infrastructure container system, wherein each of the one or more process infrastructure modules is deployable and combinable with another process infrastructure module, and wherein the manifest file comprises a YAML file and the process infrastructure modules comprise computer-readable instructions configured to trigger the desired operation.

17. The process infrastructure platform of claim 16, wherein the process infrastructure modules are configured to be customized based on user inputs to deploy the container system on a new platform.

18. The process infrastructure platform of claim 16, wherein the YAML file comprises name, description, access permissions, or combinations thereof of one or more process infrastructure modules.

19. The process infrastructure platform of claim 18, wherein the YAML file further comprises details of connections between one or more infrastructure modules.

20. A method for implementing a process for a client platform, the method comprising:
receiving inputs from a user of the client platform corresponding to a desired operation to be performed on the platform;
packaging a process infrastructure container system to perform the desired operation, wherein the process infrastructure container system comprises one or more process infrastructure modules and a corresponding manifest file with associated details of the process infrastructure modules, wherein each of the one or more process infrastructure modules corresponds to a respective software component and the software components are integrated by implementing multiple process infrastructure modules within the process infrastructure container system, wherein each of the one or more process infrastructure modules is deployable and combinable with another process infrastructure module; and
deploying the packaged process infrastructure container system on the client platform.

21. The method of claim 20, wherein one or more process infrastructure modules comprise computer-readable instructions configured to trigger the desired operation on the client platform.

22. The method of claim 20, wherein the manifest file comprises a YAML file.

23. The method of claim 20, wherein the method further comprises managing and distributing the packaged process infrastructure container system to a plurality of users.
